(19) United States
(12) Patent Application Publication
(10) Pub. No.: US 2018/0351830 A1
(43) Pub. Date: Dec. 6, 2018

(54) STORAGE OF MEDIA CONTENT OF AN ELECTRONIC MEDIA DISTRIBUTION SYSTEM IN A SECURE DISTRIBUTED DATABASE

(71) Applicant: The Marlin Company, Wallingford, CT (US)

(72) Inventors: Frank Kenna, III, Branford, CT (US); John R. Suchecki, Avon, CT (US)

(21) Appl. No.: 16/101,713

(22) Filed: Aug. 13, 2018

Related U.S. Application Data
(63) Continuation-in-part of application No. 13/772,084, filed on Feb. 20, 2013.

(51) Int. Cl. H04L 12/24; G06F 17/30; H04L 9/06

(52) U.S. Cl. CPC H04L 41/509; G06F 17/3005; H04L 2209/38; H04L 9/0637; G06F 17/30575

(57) ABSTRACT

Aspects of the invention include receiving, by a controller of a customer display device of a subscriber, an electronic media collection for presentation at the display device. The electronic media collection includes media content files and a placeholder for a custom generated media content file stored in a secure distributed database. The custom generated media content file is retrieved from the secure distributed database, and the custom generated media content file is integrated with the media content files in the electronic media collection. The electronic media collection, including the custom generated media content file, is displayed on the display device of the subscriber.

### CROSS REFERENCE TO RELATED APPLICATIONS

This application is a continuation-in-part of application Ser. No. 13/772,084, filed Feb. 20, 2013

### FIELD OF THE INVENTION

The present invention relates generally to a system for publishing and distributing employee communications, and more particularly to a system that provides storage of media content of an electronic media distribution system in a secure distributed database.

### BACKGROUND OF THE INVENTION

Effective communications between management and employees is important for modern business management. Use of a bulletin board upon which printed material, such as, posters including photographs, artwork, designs, slogans, and/or messages are displayed have been used in the past.

In recent years, systems for presenting electronic communications have been developed that provide significant advantages over known paper systems. For example, U.S. Pat. Nos. 7,765,273 and 7,743,112 both describe a system and method for the distribution of electronic media content. These systems provided significant improvements over known communication systems by allowing a user to present electronic communications to employees by assembling a media kit of information and assigning the various media data to be presented at various times. Additionally, these systems allow a user to select pre-assembled media content generated and provided by the service provider to the subscriber for selection and inclusion in the user's media kit. The selected pre-assembled media content can be displayed “as is” or modified by a user prior to the content being displayed. In addition, a user can generate new content for display by the system.

Accordingly, while existing electronic communication systems are suitable for their intended purpose, what is needed is a system having certain features of embodiments of the present invention.

### SUMMARY

In an exemplary embodiment, a method for storage of media content of an electronic media distribution system in a secure distributed database is provided. A non-limiting example method includes include receiving, by a controller of a customer display device of a subscriber, an electronic media collection for presentation at the display device. The electronic media collection includes media content files and a placeholder for a custom generated media content file stored in a secure distributed database. The custom generated media content file is retrieved from the secure distributed database, and the custom generated media content file is integrated with the media content files in the electronic media collection. The electronic media collection, including the custom generated media content file, is displayed on the display device of the subscriber.

Other objects of the invention and its particular features and advantages will become more apparent from consideration of the following drawings and accompanying detailed description.

### BRIEF DESCRIPTION OF THE DRAWINGS

Referring now to the drawings, wherein like reference numerals designate corresponding structure throughout the views.

FIG. 1 is a block diagram of an electronic media distribution system in accordance with one or more embodiments of the present invention;

FIG. 2 is block diagram of an electronic media distribution system in accordance with one or more embodiments of the present invention;

FIG. 3 is a partial flow diagram of a method for distributing electronic media according to the system of FIG. 2 in accordance with one or more embodiments of the present invention;

FIG. 4 is a partial flow diagram of a method for distributing electronic media according to the systems of FIGS. 1 and 2 in accordance with one or more embodiments of the present invention;

FIG. 5 is an annotated diagram of a representative electronic display according to FIGS. 1 and 2 in accordance with one or more embodiments of the present invention;

FIG. 6 is a representative screen generated by application software which a subscriber may use in connection with the apparatus and method of FIGS. 1 and 2 in accordance with one or more embodiments of the present invention;

FIG. 7 is an illustration of a web page illustrating a media content library that is searchable via a key word in accordance with one or more embodiments of the present invention;

FIG. 8 is a flow diagram of a process for storing media content in an electronic media distribution system using a secure distributed database in accordance with one or more embodiments of the present invention;

FIG. 9 is a flow diagram of a process for retrieving media stored in a secure distributed database of an electronic media distribution system in accordance with one or more embodiments of the present invention; and

FIG. 10 is a block diagram of a system for utilizing a secure distributed database for storing subscriber generated media content in an electronic media distribution system in accordance with one more embodiments of the present invention.

### DETAILED DESCRIPTION OF THE INVENTION

In accordance with one or more embodiments of the present invention, a user is provided with a tool to create new media content for inclusion in a user media kit. The new media content can be stored in a secure distributed database such as, but not limited to, a blockchain. Blockchain technology can be utilized by one or more embodiments of the present invention to provide a secure, decentralized framework for the controlled sharing of media content files that may include, for example, private company and/or employee information. In accordance with one or more embodiments of the present invention, media content security is provided by encrypting the customer-created media content files, segmenting each customer-created media content file into “N” pieces, and sending the “N” pieces to anonymized nodes in the network. In this manner, access by unauthorized users to private data such as company secret data or private employee data can be prevented.

In addition, blockchain technology can be utilized to verify with a very high degree of accuracy (e.g., about one-hundred percent) when and where a media content file was displayed. This can be useful to determine and/or to demonstrate compliance with regulations that require that particular information be provided to a particular employee or a particular group of employees.

In accordance with one or more embodiments of the present invention, a media library feature is provided that allows a user to search and download content to add to a user media kit. The media library enables users to quickly and easily search by keyword for content addressing specific workplace topics. The content can then be uploaded to virtual frames on the user's computer screen so that the user can preview how the content will appear on the user's display prior to actually presenting the data on their own equipment.

One or more embodiments of the present invention include an electronic communication system (ECS) that includes a controller and a display located at a customer location. A user has access to a service provider computer (e.g., server) to access the ECS by means of a web page. In accordance with one or more embodiments of the present invention, the user is able to log on to the web page and view a media kit that includes the electronic communications the user has selected to be transmitted to the controller and ultimately presented on the user's display(s).

The provider, using a service provider system (SPS) may design and store certain electronic employee communications suitable for a variety of business types (e.g., manufacturing, sales, service, etc.). The electronic employee communications may be provided to businesses as, for example, a subscription service. In one or more embodiments, the user/subscriber may provide information about their business to the provider to aid the provider's software in selecting and presenting pertinent electronic employee communications. The user/subscriber may be granted access to the provider's server to enable the user/subscriber to choose, alter, and/or generate new custom electronic employee communications, which are to be delivered to the subscriber's electronic display.

In one or more embodiments of the present invention, a system is provided that allows for selection of pre-assembled media content. It is contemplated that the subscriber may categorize particular media content into collections (e.g., certain media content is selected to be displayed for maintenance personnel while other selected media content may be selected to be displayed for management personnel). It is further contemplated that the various collections may be linked to certain groups, playlists or campaigns (e.g., it is determined that while the various maintenance personnel at the subscribers' various complexes may not be presented with an identical presentation, there are particular media collections that will be displayed at all maintenance displays).

In one or more embodiments of the present invention, the media library includes a database of employee communications that are indexed by key word. For example, the user may type in “safety” and be presented with a table listing a count of how many individual communications include that key word. Once the user clicks on the key word, it is contemplated that a select number (e.g. the first ten) of electronic communications are presented to the user to select from. As the user advances through the list, if the user sees a particular communication that the user would potentially like to add to the user's media kit, the user need only click on the electronic communication and can add it to one of the frames in a virtual display presented on the user's computer screen. In one or more embodiments, the system includes an interface (e.g., a link in the form of a button positioned adjacent to each electronic communication) that can be clicked on to run or play the electronic communication. For example, if a user is going through the list of electronic communications associated with a particular key word and sees a particular electronic communication they would like to run, the user need only click on the button to run and view the content.

In accordance with one or more embodiments of the present invention, another interface is provided where if the user determines that a particular electronic communication should be added to the user's electronic media collection, the user need only click on the “add” button for the particular electronic communication to be added to the electronic media collection. Once the user has added all the electronic communications desired related, for example, to the key word “safety”, the user can look for content under another key word, such as “service.” The user can follow the same process again and again to build a custom media kit using pre-assembled media data in a very quick and easy manner. Once the user has assembled all the various electronic communications into an electronic media collection the user may have the option to view the various electronic communications.

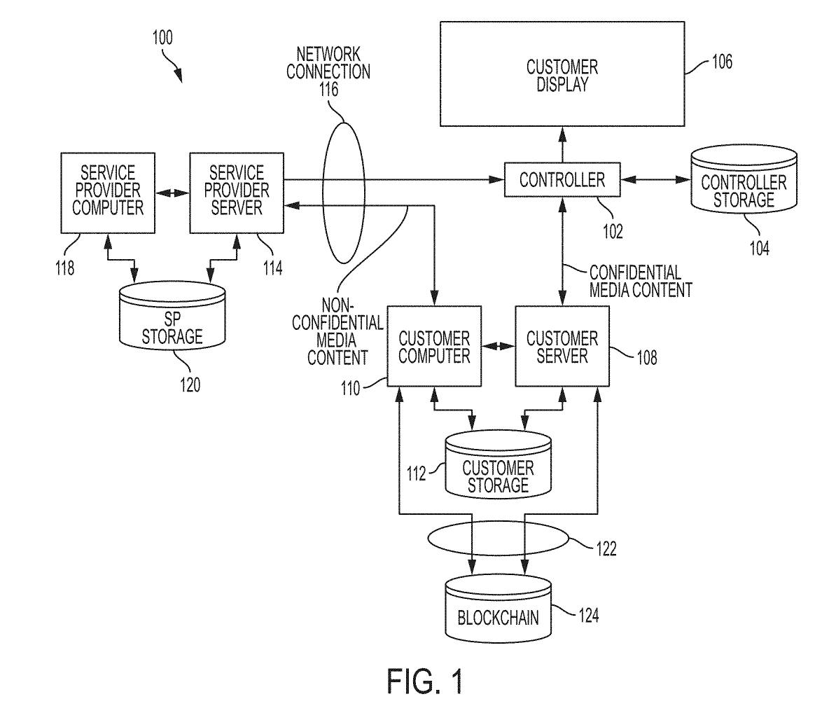

FIG. 1 is a block diagram of an electronic media distribution system 100 in accordance with one or more embodiments of the present invention. Electronic media distribution system 100 includes a controller 102 coupled to a customer display 106 and a customer server 108, the controller 102 having a controller storage 104. Also illustrated in FIG. 1 is customer server 108 and a customer computer 110 coupled to customer storage 112. Additionally, a service provider server 114 is shown variously coupled to controller 102 and to customer computer 110 via a network connection 116. As illustrated in FIG. 1, service provider computer 118 is coupled to service provider storage 120 and service provider server 114.

Controller 102 may include any type of electronic programmable controller capable of receiving electronic data and transmitting the received data to a video display. In addition, the customer display 106 may include any type of video display. In one or more embodiments, customer display 106 is a flat panel video display of about 26 inches (66 centimeters) in height and about 63 inches (160 centimeters) in width. As shown in FIG. 1, the controller 102 is coupled to service provider server 114 via network connection 116 which may be implemented by any wired or wireless communication technologies known in the art. The network connection 116 may be implemented using one or more cellular, satellite, and terrestrial communication technologies, as well as long and/or short-range communications protocols (e.g., Bluetooth™, WiFi, and Zigbee, etc.).

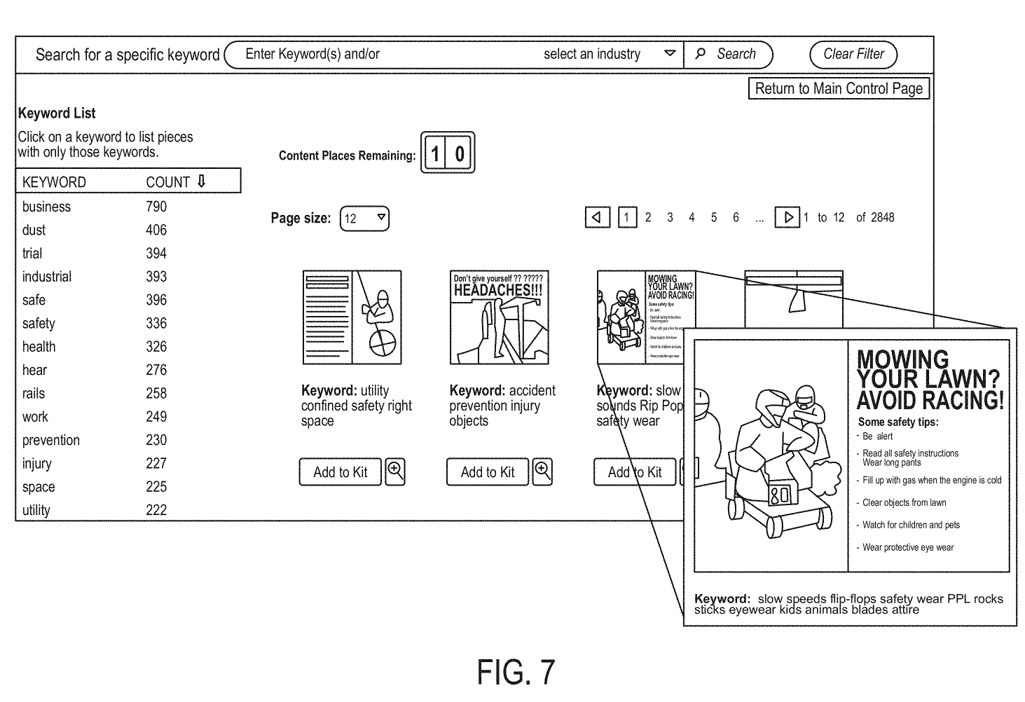

A subscriber is able to access a variety of media content provided by the service provider to the subscriber. For example, the subscriber is provided with pre-assembled media content generated and provided by the service provider. This pre-assembled media content includes media information the service provider has assembled and believes would be of interest to the subscriber (FIG. 7). The service provider may further suggest certain media content to the subscriber, which the subscriber may or may not select for display to its employees, via, e.g., the customer display 106. In addition, the service provider may continually update the pre-assembled media content to provide fresh information to the subscriber so as to keep employees interested in the displayed information.

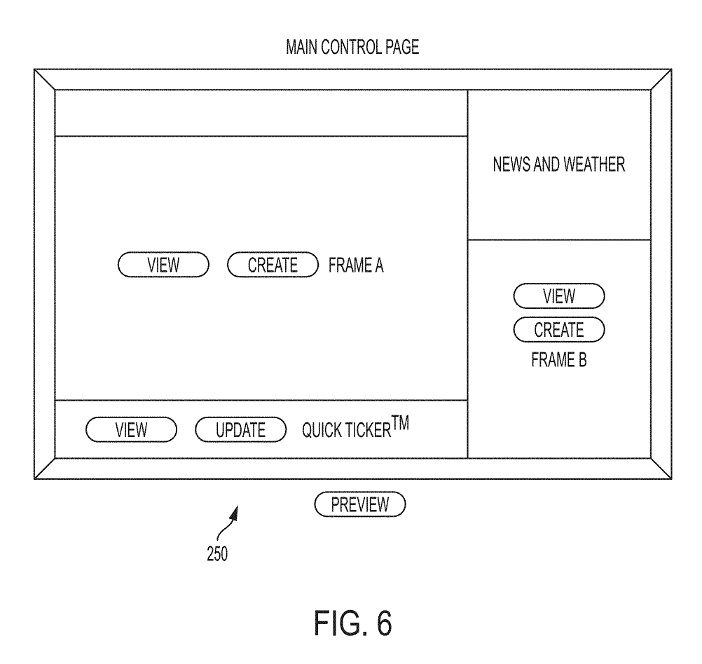

Also provided for the subscriber is the ability to modify the pre-assembled media content. For example, the subscriber may wish to present some of the pre-assembled media content to its employees with some minor changes particular, for instance, to the site location. The subscriber may select the pre-assembled media content and, by means of editing tools in the system software (e.g., FIG. 6), may modify the pre-assembled media content as desired. This may include, adding new content to the pre-assembled media content, deleting certain media content, rearranging the media content including altering the size, look and feel of the media content, altering the play time or play order for certain media content and so forth.

Still further, the subscriber may wish to generate entirely new media content completely unrelated to any of the pre-assembled media content. Again, the subscriber is provided with the tools to be able to compile virtually any information or data desired to be displayed on customer display 106. Both the modified pre-assembled media content and the entirely new media content are referred to herein as “new media content” or “custom generated media content.”

Once the subscriber has viewed, modified and/or generated the media content to be displayed, the subscriber may compile an electronic media collection, which includes all the information that the subscriber desires to be played on the customer display 106. The subscriber may further assemble the media content to play in a desired play order including selecting the length of time each segment of information will be displayed on the customer display 106.

The electronic media collection may be stored on service provider storage 120. In this manner, a subscriber may access and select certain pre-assembled media content and save an electronic media collection on service provider storage 120. In addition, the subscriber may access and modify certain pre-assembled media content and save the modified content in the electronic media collection. Still further, the subscriber may generate completely new media content, which may also be saved in the electronic media collection on service provider storage 120.

It is contemplated that the subscriber may generate non-confidential information that need not be stored on the customer's system. Non-confidential media content can be uploaded to service provider server 114 and saved on service provider storage 120 as desired.

It also contemplated that the newly generated media content may include sensitive confidential information that the subscriber wants to protect as confidential. The subscriber may generate the confidential media content on, for example, customer computer 110 and store an encrypted version of the confidential media content in customer storage 112 and/or in a secure distributed database, such as blockchain 124, via network connection 122. When the confidential media content is stored in customer storage 112, when assembling the electronic media collection, rather than placing the confidential media content on service provider server 114, the customer may simply provide the service provider server 114 with an identifier of the document (e.g., document name) and a document location pointer. When the confidential media content is stored in blockchain 124, when assembling the electronic media collection, rather than placing the confidential media content on service provider server 114, the customer may simply provide the server provider server 114 with an identifier of the document (e.g., media content file name) and document location pointer to a location(s) (e.g., a hashtag) in the blockchain 124.

In accordance with one or more embodiments of the present invention, the electronic media collection is downloaded to controller 102 from service provider server 114 and saved on controller storage 104. When the electronic media collection is run by controller 102, at any point in the program where confidential media content is to be played, the controller 102 is directed to obtain that information from either customer storage 112 or blockchain 124 using, for example, the identifier of the document and the hashtag. In this manner, the confidential media content is integrated with the other media content files in the electronic media collection. In one or more embodiments of the present invention, controller 102 includes computer instructions to act as a local blockchain worker node of blockchain 124 and is coupled to customer server 108 to obtain and decrypt the confidential media content saved on blockchain 124 before displaying it on customer display 106. In this manner, the subscriber may generate confidential media content that will be maintained securely on the blockchain 124. In one or more other embodiments of the present invention, the computer instructions to implement the local blockchain worker node of blockchain 124 are located on the customer server 108 or on another processor (not shown) that is local (e.g., coupled to physically or via a short-range communication protocol) to controller 102.

Similar to network connection 116, network connection 122 may be implemented by any wired or wireless technologies known in the art. The network connection 116 may be implemented using one or more cellular, satellite, and terrestrial communication technologies, as well as long and short-range communications protocols (e.g., Bluetooth™, WiFi, and Zigbee, etc.).

The electronic media distribution system 100 shown in FIG. 1 provides control of the media content to be played on customer display 106. In addition, the electronic media distribution system 100 also allows any highly confidential information to be integrated, or included, into the electronic media collection from a subscriber location and/or from a secure distributed database.

The subscriber may also set up the system to automatically update the electronic media collection with new pre-assembled media content as such becomes available. Alternatively, the subscriber may set the system up to provide the subscriber with a notification that new pre-assembled media content for the subscriber's review and authorization to play. Still further, the subscriber may set the system up such that the electronic media collection can only be updated manually.

In one or more embodiments, controller 102 queries service provider server 114 for an electronic media collection to be run on an associated customer display 106. It is contemplated that controller 102 may query service provider server 114 at a period time interval (e.g., every fifteen minutes), such that the electronic media collection is automatically updated. The automatic query function also may provide a diagnostic tool for electronic media distribution system 100. For example, if the controller 102 does not query service provider server 114 within a certain time frame, the electronic media distribution system 100 may provide an alert to the service provider or the subscriber regarding such. In this manner, the system will not experience significant “down time” due to no one being aware that controller 102 is not functioning properly.

Another advantage of one or more embodiments is that, since controller 102 downloads the electronic media collection and stores it in controller storage 104, which may or may not be a cache memory location, upon severing of the network connection 116, the controller 102 can continue to play the electronic media collection on customer display 106 until the network connection 116 is re-established.

In accordance with one or more embodiments of the present invention, the service provider computer 118, service provider server 114, and service provider storage 120 are located a service provider location; and the customer display 106, controller 102, controller storage 104, customer computer 110, customer server, and customer storage 112 are located at a customer, or subscriber location. The elements located at the service provider location can be referred to collectively herein as a service provider system (SPS). The elements located at the customer location can be referred to collectively herein as an electronic communication system (ECS).

While FIG. 1 has been discussed in connection with only one customer display 106 location, it is contemplated that the subscriber may have many differing display locations, whether in the same complex or in many differing complexes. The subscriber is given maximum control of the media content provided to the various displays as described above.

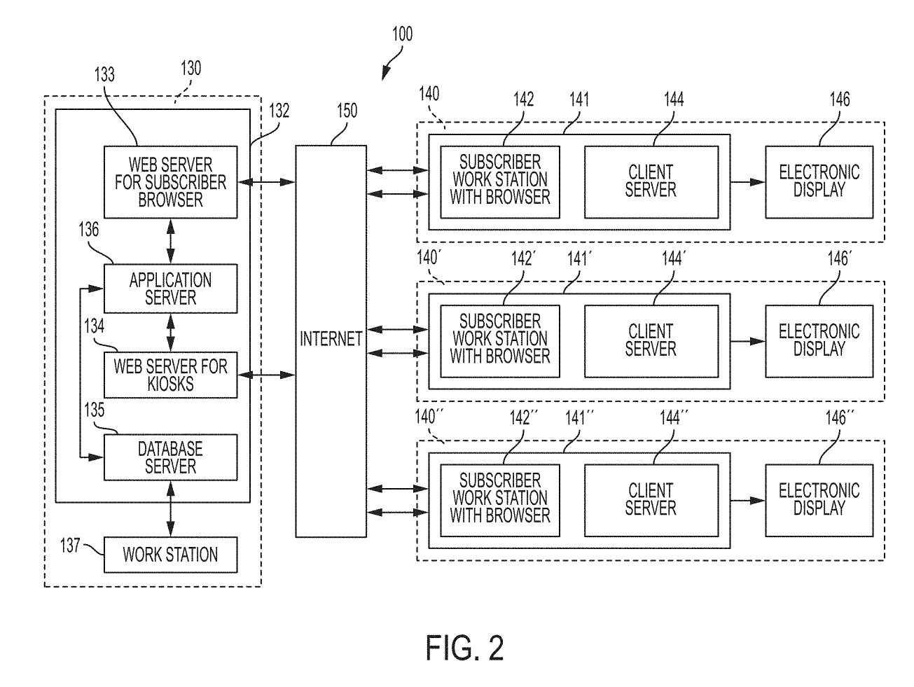

Referring now to FIG. 2, a system for distribution of electronic media, electronic distribution media system 100, facilitates electronic transmission of employee communications from a primary location to one or more remote subscriber locations in accordance with one or more embodiments of the present invention. The employee-directed communications may take the form of a “poster” as that term is commonly understood, where the poster is created and maintained in electronic form. A typical media collection may include text and graphics arranged to be visually attractive and convey information pertinent to a subscriber's business, workplace or employees. The subject matter of the employee-directed communications may involve safety, quality, teamwork, morale, self-motivation, subscriber news releases, employee activities and the like.

The term “employee-directed communication” or “employee communication” as used herein is intended to include all forms of visual communication including graphics, written and printed text along with photographs, visual works and artistic material displayed either alone or in any combination. Particular employee communications may take the form of an electronic media collection or poster as described above and further include video and audio presentations. The employee-directed communications may be initiated by the subscriber, as well as an employee of the subscriber.

The electronic media distribution system 100 includes a main server system 130 located at a primary location and a multiplicity of client or subscriber communication and display systems 140, 140′, 140″ located at each remote subscriber location. The subscriber communication and display systems 140, 140′, 140″ communicate with the main server system 130 via, for example, an Internet connection 150, or other suitable communications pathway. In one or more embodiments, the main server system 130 is service provider system, and each of the computers 141, 141′, 141″ is an electronic communication system.

The main server system 130 includes a computer 132 configured to function as a first web server 133, a second web server 134, a data base server 135, and an application server 136. While the main server system 130 is described in terms of several services and server functions, a single computer 132 may be configured to provide all functions and incorporate all described services. The computer 132 may be any commercially available server such as those manufactured and marketed by the Compaq Corporation or may be or include, for instance, any personal computer running any version of the Windows® operating system, Unix®, Linux®, Solaris®, MacOS® or other operating system or platform. Computer 132 may also be or include any microprocessor-based machine, microcontroller, or other general or special purpose device operating under programmed control. In addition, computer 132 may be connected to the Internet connection 150 in any manner known in the art. The first web server 133 is configured to be accessible by one or more subscriber work stations 142, 142′, 142″ to allow subscribers to modify the content of the employee communications.

The second web server 134 may be similar to web server 133 although modified to communicate via with one or more client servers 144, 144′, and 144″. It will be understood that while two web servers 133 and 134 are provided, one web server performing both functions may be employed instead.

The database server 135 may be used to store subscriber information such as subscriber identification, business type, routing information and media data such as employee communication collections developed at a workstation 137 and as modified by the application server 136 as discussed below. Numerous workstations 137 may be employed. Each workstation 137 is configured so that a graphic designer may develop electronic employee communications (which may take the form of electronic media collections) and collect them together into employee communication collections which may contain, for example, collections of media collections and messages for a particular subscriber. The employee communications are created at the workstation 137, using software such as, but not limited to, Adobe Photoshop™, Adobe After Effects™ and Photoshop After Effects™. The electronic employee communications are then sent to application server 136 where they are organized by edition and subscriber. The work station 137 communicates with the data base server 135 to transmit various electronic employee communications, etc., which are developed at the work station 137 in a conventional manner. The electronic employee communications are converted into an appropriate format for transmission over the Internet connection 150, and then stored before transfer to a client communication and display system 140, 140′, 140″.

The application server 136 communicates with both the first and second web servers 133, 134 and with the data base server 135. The application server 136 provides coordination between the web servers 133 and 134 and allows access to the electronic media collections contained in data base server 135. The application server 136 includes application software that tracks and distributes content according to subscriber data and as modified by subscribers according to the method of the present invention.

The client communication and display system 140, 140′, 140″ includes a computer 141, 141′, 141″ respectively, that may include a subscriber workstation 142, 142′, 142″, a client server 144, 144′, 144″, and an electronic display 146, 146′, 146″ (e.g. a flat panel display). The subscriber workstation 142, 142′, 142″ communicates with the web server 133 via the Internet connection 150. The subscriber workstation 142, 142′, 142″ may include any web browser known in the art. The subscriber workstation 142, 142′, 142″ interactively communicates with web server 133 to transmit subscriber input, for example, to modify an employee communication collection and receive an updated version of the employee communication collection.

The electronic display 146, 146′, 146″ may be any suitably large electronic display such as, but not limited to a large flat panel gas plasma, LCD, LED or OLED display, such as those manufactured and sold by the Sony corporation of Japan.

The client server 144, 144′, 144″ receives employee communication collections (alternatively referred to as electronic media collections) in the form of data in a particular format, for display on the electronic display 146, 146′, and 146″. It will be appreciated that the computer 141, 141′, 141″ may be located on a housing supporting the electronic display 146, 146′, 146″, or it may be separated some distance therefrom. In any event, the client server 144, 144′, 144″ communicates with the web server 133 via the Internet connection 150. The client server 144, 144′, 144″ can include a web browser, which may be configured in a display mode whereby the browser receives data from the web server 133 and generates a continuous display. In particular, it will be understood that a number of channels of the web browser may be used to simultaneously display various elements of the employee communications collection for varying amounts of time.

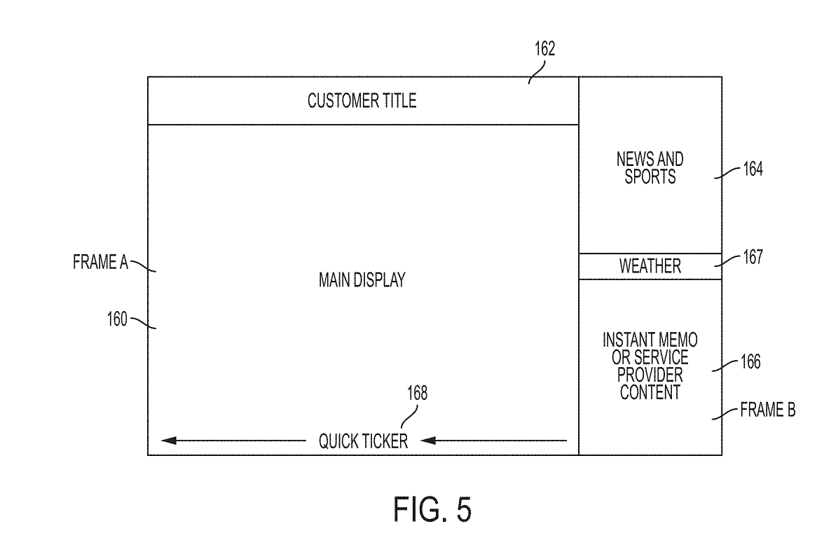

The client server 144, 144′, 144″ communicates employee communication collections (electronic media collections) to the electronic display 146, 146′, 146″ for display. The electronic display 146, 146′, 146″ may include a plurality of sections for displaying different materials (FIG. 5). For example, as seen in FIG. 5, four separate sections 160, 162, 164 and 168 may be provided—each of which may be functioning simultaneously and at different update times and periods. Each section may sequentially display varying messages and/or visual media content, slogans, etc. For example, in section 160 (Frame A) audio/visual electronic media content may be played or shown for a specified time period, e.g. fifteen (15) minutes, and then switch to custom executive media content. Section 166 (Frame B) may display, concurrently with the employee communications displayed on section 160, an employee communication, then switch, for example, to service provider safety content, media content and thereafter switch, for example, to an inspirational quotation. The relative timing may also be selected. For example, the messages may alternate every fifteen (15) minutes and may start seven and one half (7.5) minutes after the electronic media content is initially displayed in section 160. Section 164 may display news or announcements such as news headlines, sports scores and may be additionally split into a subsection 167 for display of local current and/or 3 or 5-day weather forecasts. The electronic display 146, 146′, 146″ may include media such as a client's name or trademark, etc. as illustrated at 162, which may be permanently affixed thereto.

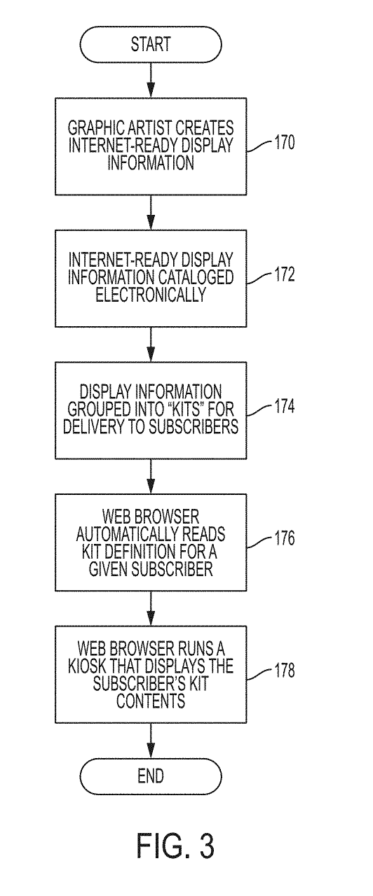

With reference to FIGS. 2, 3, and 4, a graphic artist using work station 137 creates an employee communication in electronic form that is compiled into an employee communications collection in a data format, as discussed above, that is suitable for transmission over the Internet as shown at 170 (FIG. 3). The electronic employee communications are cataloged and stored in the data base server 135 at 172 (FIG. 3). In one or more embodiments, the data base server 135 may also receive subscriber and/or subscriber employee-generated communications.

The application server 136 and workstation 137 function to group electronic employee communications by topic and edition. The electronic employee communications may also be compiled into employee communications collections arranged by, for example, a particular subscriber or subscriber type such as retail or manufacturing subscribers at 174 (FIG. 3.) For example, the subscribers of display systems 140 and 140′ may have access only to one set of electronic media collections while the subscriber of display system 140″ has access only to a different set of electronic media collections. The application server 136 is also configured to indicate the last time and date that revisions or updates have been made to the employee communication collections.

Each subscriber may modify these collections using a subscriber workstation 142, 142′, and 142″. The subscriber may select specific electronic employee communications (electronic media content) for display on the electronic display 146, 146′, and 146″. Thereafter, the client server 144, 144′, 144″ communicates the electronic employee communications to the electronic display 146, 146′, 146″ at 176 (FIG. 3), as described above, for display at 178 (FIG. 3). The subscriber can query through the web browser to determine the latest times and dates of electronic media collection changes.

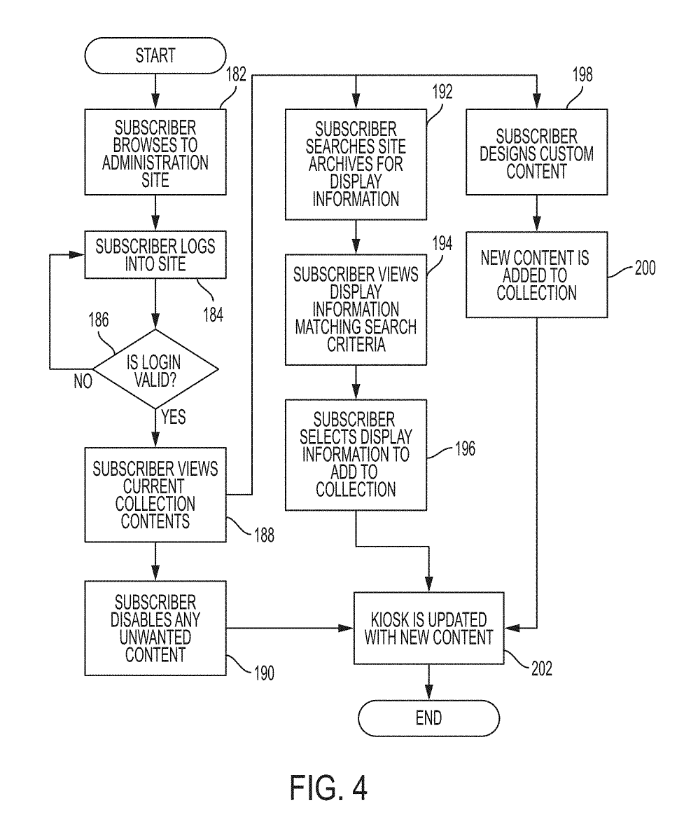

The subscriber may also modify the contents of an employee communication collection. Using a subscriber workstation 142, 142′, 142″, the subscriber contacts the web server 133 (see, 182 and 184 of FIG. 4) and logs onto the web server 133. After checking for proper password and client ID at 186, the subscriber is allowed to view the current employee communication collection contents at 188. The subscriber may then choose between different options. The subscriber may search for electronic employee communications by topic, for example, electronic media content with themes such as safety, attitude, cooperation, etc. The subscriber may further remove any unwanted visual electronic media content or other content at 190. The subscriber may also search, using the application server 136, to select particular electronic media content or display information and add the selected media content to the employee communications collection at 192, 194 and 196. The subscriber may have access to various screens such as screen 250 (FIG. 6) to facilitate the search and selection. Optionally, the subscriber may design its own electronic media content within the application or simply provide electronic material for display, all of which may be added to the employee communications collection at 198 and 200. Once a subscriber has completed the modification, the application server 136 makes the updated employee communications collection available. Accordingly, when the client server 144, 144′, 144″ polls the web server 133, new media data is downloaded for display on the electronic display 146, 146′, 146″ as shown at 202 (FIG. 4).

As indicated above, an employee (also referred to as “end user”) of the subscriber may select, generate, and post media content for distribution to display devices and/or other employee devices (e.g., a computer, tablet PC, smart phone, etc., collectively referred to herein as “end user computers”). Permissions-based interaction among employees may also be implemented.

FIG. 7 depicts a web page illustrating a media content library that is searchable via a key word. For example, a user/subscriber may log on to service provider server 114 as previously discussed in connection with FIGS. 1 and 2. Once the user/subscriber is logged in, the user has the option to access a media content library that is saved on service provider storage 120.

The media content library is searchable via a key word search function as depicted, for example, on the left side of the screen. In one or more embodiments, the user/subscriber has the option to scroll through the various key words provided in the form of a list with an associated number count corresponding to the total number of discrete media pieces that are associated with the particular key word. Alternatively, the user/subscriber can simply type the key word in to the system as indicated at the top of the screen that the various media associated with the key word will be displayed.

It should be understood that the various media will be displayed on the screen for the user/subscriber to select from. In one embodiment the number of discrete media that will be displayed at one time is selectable. Further, as can be seen with reference to FIG. 7, a thumbnail for each discrete media piece may be presented to the user/subscriber where the system provides a first interface (labeled “Add to Kit”) and a second interface (labeled with a magnifying glass).

The first interface allows the user/subscriber to add the particular pre-assembled media content to the user/subscriber's electronic media collection. The second interface (the magnifying glass), allows the user/subscriber to see an expanded view of the particular media content. In one or more embodiments, the particular media content expanded in the window as shown in FIG. 7, may run if it includes video.

Once the user/subscriber has added all the pre-assembled media content to the user/subscriber's electronic media collection, the user/subscriber has the option to view the electronic media collection in a virtual display as illustrated in FIG. 6. For example, the various media content will be displayed on the virtual display allowing the user/subscriber to view, modify and edit the electronic media collection as desired. It may be that certain additional media content is desired, or that certain media content be removed, or that the duration that certain media content is displayed by adjusted.

It is further understood that the user/subscriber's key word search (es) may be saved by the system such that when additional or new media content is generated or becomes available that is associated with the key word search the user/subscriber performed, that a notification may be provided relating to the new content. For example, if the user/subscriber searched for the term “safety”, the system may save the key word search term and when new content becomes available relating to “safety” a notification may be made available to inform the user/subscriber of the new content. The notification can be in the form of a message that is presented to the user/subscriber when they log on to the service provider server 114. Alternatively, the notification could be in the form of an email or a text message that is delivered to the user/subscriber. When the user/subscriber logs back on to the system, the new media content may be presented, or certain key words presented in the list on the left side of the screen may be highlighted or be provided in a different color (e.g. green) indicating to the user/subscriber that new content is associated with the key word.

As described herein, in accordance with one or more embodiments media content files can be stored in a secure distributed database such as a blockchain, or blockchain ledger. As known in the art, a blockchain is a continuously growing list of records, called blocks, which are linked and secured using cryptography. Each block typically contains a cryptographic hash of the previous block, a timestamp and transaction data. By design, a blockchain is inherently resistant to modification of the data. It is an open, distributed ledger that can record transactions between two parties efficiently and in a verifiable and permanent way. For use as a distributed ledger, a blockchain is typically managed by a peer-to-peer network collectively adhering to a protocol for inter-node communication and validating new blocks. Once recorded, the data in any given block cannot be altered retroactively without the alteration of all subsequent blocks, which requires collusion of the network majority.

As utilized by one or more exemplary embodiments of the present invention, blockchain technologies provide a secure, decentralized framework for the controlled sharing of company and employee information. A blockchain ledger is used by one or more embodiments of an electronic media distribution system, such as electronic media distribution system 100 of FIG. 1, to store media data having contents that a subscriber does not want to store on a service provider system. For example, a company with multiple locations may want to transfer information securely between company locations to display on their electronic communication system (e.g., digital signage) screens without having the information pass through the service provider system.

In accordance with one or more embodiments of the present invention, the user uploads a document (e.g., a media content file) using a blockchain layout. The media content file is split into multiple pieces, encrypted, and stored on other electronic communication system computers in the network that have previously opted in to be part of the blockchain ledger. The other computers can be other computers in a company network so that the data never leaves the company, thus implementing a private blockchain. Alternatively, the other computers can be in a network that includes other subscribers to an electronic media distribution system, such as electronic media distribution system 100 of FIG. 1, thus implementing a semi-private blockchain. The other computers can be in a public network, thus implementing a public blockchain. By storing the data in a blockchain, the only unencrypted information transferred over the Internet to the service provider is identifying information such as a document identifier (e.g., document name), and optionally an identifying service provider assigned public key used by the service provider system to keep track of the document.

In accordance with one or more embodiments of the present invention, an identifier of the document (e.g., document name) and a document location pointer (e.g., service provider public key or hash tag) are stored in the service provider storage, such as server provider storage 120 of FIG. 1, as part of an electronic media collection. When it is time for the document to be displayed on a display of an ECS, such as customer display 106 of FIG. 1, the player, such as controller 102 of FIG. 1, retrieves the document from the blockchain ledger at the location specified by the service provider public key using the matching private key stored by the player when it created the document. The player reassembles the pieces, unencrypts the document, and displays the document on the provider display (e.g., integrates the document with the media content files in the electronic media collection). In one or more embodiments of the present invention, the customer's private key is configured on each client server, such as client server 144 of FIG. 2. An audit trail of all transactions (e.g., storing the document and retrieving the document for display) can be maintained, or kept, on the unalterable blockchain ledger, thereby establishing accountability and transparency in the data exchange process.

In accordance with one or more embodiments of the present invention, instead of displaying the document on the provider display, the document is downloaded to a local user's computer, such as customer computer 110 of FIG. 1. In this manner, the electronic communication system can be used as a secure document transfer method for distributed companies. For example, a customer may wish to distribute a confidential financial document to several of its branch locations for managers to read. In this case, sending to the displays may not be wanted or needed. In accordance with one or more embodiments of the present invention the customer can use the blockchain technology coupled with an electronic media distribution system, such as electronic media distribution system 100 of FIG. 1, to confidentially distribute documents to one or more of the branch locations.

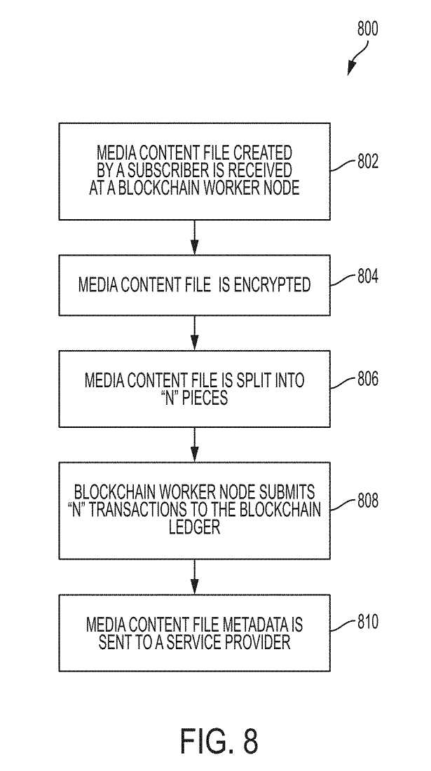

Turning now to FIG. 8, a flow diagram 800 of a process for storing media content in an electronic media distribution system using a secure distributed database is generally shown in accordance with one or more embodiments of the present invention. The processing shown in FIG. 8 can be performed, for example, by controller 102 of FIG. 1 acting as a blockchain worker node. Alternatively, the processing shown in FIG. 8 can be performed, for example, by customer server 108 of FIG. 1 acting as a blockchain worker node. At block 802, a media content file that was created by a subscriber, or customer, is received by the blockchain worker node. As described previously, the media content file, or employee-directed communication, can include any form of visual communication such as, but not limited to graphics, text, and photographs. At block 804, the media content file is encrypted by the blockchain worker node. Any known encryption method can be used such as, but not limited to, 256 or 512 bit encryption technology. Encrypting the media content prevents others from being able to read the media content when it is stored in the blockchain ledger.

At block 806, the encrypted media content file is split into “N” pieces, wherein “N” is greater than one and can vary based on the size of the encrypted media content file and the blockchain ledger transaction size. At block 808, the blockchain worker node submits “N” transactions to the blockchain ledger using a customer specific private key and the “N” pieces of the encrypted media content file are stored in all blockchain ledger locations (e.g., different computers or nodes) in the blockchain ledger. At block 810, the metadata about the media content file (e.g., document name and location pointer) is sent to the service provider.

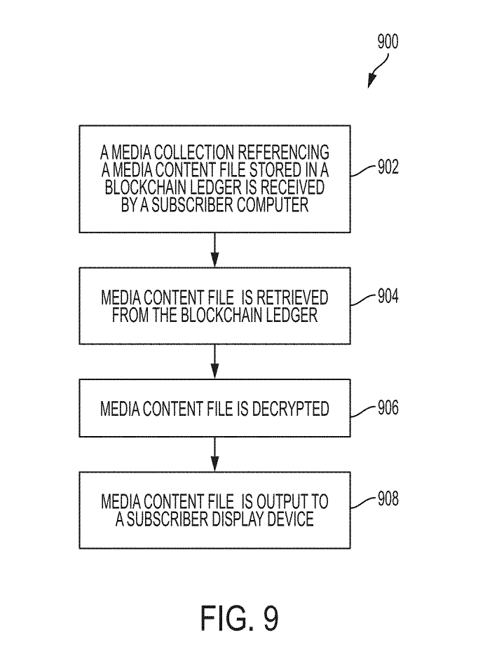

Turning now to FIG. 9, a flow diagram 900 of a process for retrieving media stored in a secure distributed database in an electronic media distribution system is generally shown in accordance with one or more embodiments of the present invention. The processing shown in FIG. 9 can be performed for example, by controller 102 of FIG. 1. Alternatively, the processing shown in FIG. 8 can be performed, for example, by customer server 108 of FIG. 1 acting as a blockchain worker node. At block 902, a media collection referencing a media content file stored in the blockchain ledger is received by a subscriber computer, such as controller 102 of FIG. 1, and at block 904 the media content file is retrieved from the blockchain ledger. In accordance with one or more embodiments, each of the “N” pieces of the media content file is retrieved from a different blockchain ledger block and the media content file is reassembled. At block 906, the reassembled media content file is decrypted. The decrypted media content file is integrated into the media collection and output to a subscriber display, such as customer display 108, at block 908.

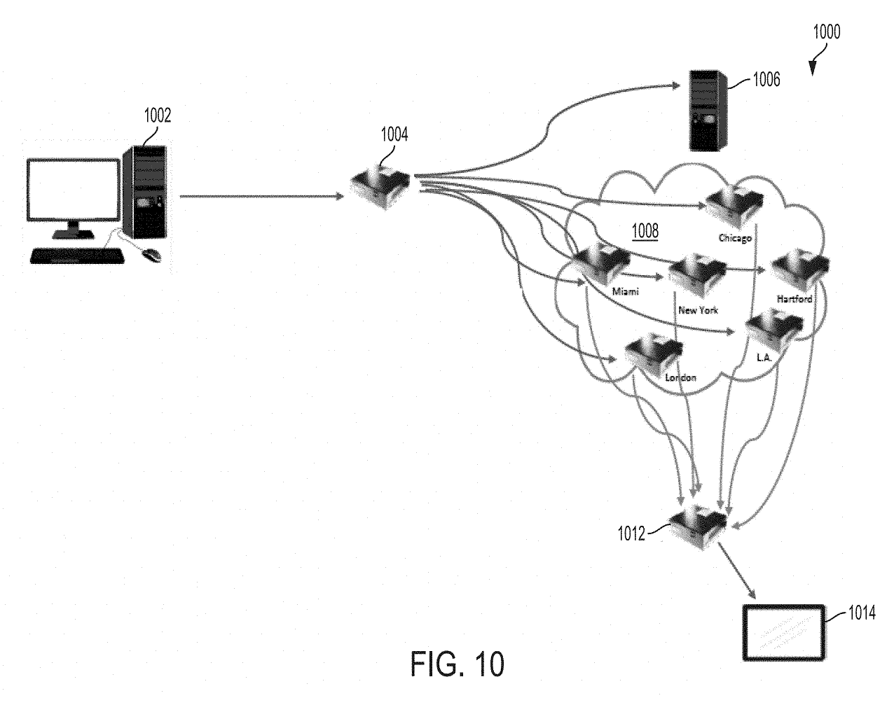

Turning now to FIG. 10, a block diagram of a system 1000 for utilizing a secure distributed database for storing subscriber generated media content in an electronic media distribution system is generally shown in accordance with one more embodiments of the present invention. The system 1000 shown in FIG. 10 includes a customer computer 1002, implemented for example by customer computer 110 of FIG. 1, that a customer uses to create a new media content file from scratch or by modifying an existing media content file. The customer accesses an administration control module and selects the blockchain option which provides access to a blockchain application residing, for example on the customer computer 1002. In alternate embodiments, all or a subset of the blockchain application resides on a local blockchain worker node 1004, on a service provider server 1006, on other worker nodes in the service provider blockchain ledger 1008 and/or in a cloud location, and the blockchain application is accessed by the customer computer system 1002 via one or more networks.

In accordance with one or more embodiments of the present invention, the customer selects a template and uploads the local media content file to a local blockchain worker node 1004, implemented for example by controller 102 and/or customer server 108 of FIG. 1. The local blockchain worker node 1004 assembles the content including, for example text, video, spreadsheets, and/or a photo. The local blockchain worker node 1004 encrypts the media content, splits the content into “N” pieces, and submits “N” transactions to the blockchain ledger 1008 using a customer specific local private key. The “N” transactions are distributed via a network, such as network connection 122 of FIG. 1, to other worker nodes in the service provider blockchain ledger 1008.

In addition, metadata associated with the media content file such as file size, date, and/or run time is sent to a service provider server 1006, such as service provider server 114, for scheduling and record keeping. The metadata can also specify the document location using, for example, a public key of the service provider. The service provider server 1006 interprets the metadata and determines which service provider computer(s) should receive the media content file. In the example shown in FIG. 10, service provider player computer 1012 is identified as being a target computer of the media content file. The player computer 1012 can be implemented for example by controller 102 and/or customer server 108 of FIG. 1. The player computer 1012 can include computer instructions to execute a blockchain application to retrieve, or read, the blockchain ledger transactions associated with the media content file using the customer private key and the service provider public key. The player computer 1012 can reassemble the media content file from the retrieved blockchain ledger transactions and then decrypt the reassembled media content file to product the original media content file stored in the blockchain ledger. As shown in FIG. 10, the media content file is displayed on display 1014.

In one or more embodiments of the present invention, the media content file is encrypted prior to being broken into pieces for storage in the blockchain ledger 1008. In one or more other embodiments of the present invention, the media content file is broken into pieces and each piece of the media content file is encrypted separately before being stored in the blockchain ledger 1008.

One or more embodiments of the present invention can be utilized when a user wants to store documents securely on a network, where many users know the name and use of the document but cannot access it without a key. For example, a company may want to store a proprietary production spreadsheet or a company directory in an area where people with the proper authorization can easily download it. These documents, and ones like them, can be loaded into a blockchain layout, encrypted, and distributed (e.g., written to a blockchain ledger). A non-encrypted table of contents may be included so that anyone on the network can see that the document is available for download, but only those with the correct key can download the document. An audit trail of all transactions is kept on an unalterable distributed ledger, establishing accountability and transparency in the data exchange process.

One or more embodiments of the present invention can be utilized by a company to create a secure repository where it can collect assets (e.g., photos or scanned documents) from third-party individuals such as employees or vendors. The company can give the third-parties a link which brings the person to a publicly-accessible blockchain layout where, upon receipt, the assets are encrypted and distributed. Contents of the repository would be visible to users, but only users with the correct key would be able to retrieve the assets. Retrieved assets can be used to create content within an ECS.

A technical issue addressed by one or more embodiments of the present invention is how to provide a subscriber with the ability to control access to and dissemination of private company data. A technical solution provided by one or more embodiments of the present invention is the ability to use a secure distributed database, such as a blockchain ledger, to store the private company data. As described herein, a placeholder that identifies the private data and a location of the private data is inserted into an electronic media collection and the subscriber controls access to the private data via the blockchain ledger.

Another technical problem addressed by one or more embodiments of the present invention is the amount of network traffic that occurs between the service provider system and the subscriber system. By storing media content files in the secure distributed database and only sending metadata to the service provider system, network traffic to the service provider system can be reduced.

A further technical problem addressed by one or more embodiments of the present invention is the amount of local storage required so store the media content files, both by the service provider and the subscriber, or customer. By storing media content files in the secure distributed database, local storage requirements at both the service provider location and subscriber location can be reduced.

A further technical problem addressed by one or more embodiments of the present invention is being able to identify and verify the source of a company document. By encrypting, date stamping, and storing data on a blockchain ledger, the source (or creator) of a company document is known and can be guaranteed.

One or more embodiments of the present invention also provide the technical benefit of being about to identify, verify, and guarantee employee identities, certifications, security levels, and titles thought the use of data that is encrypted, date stamped and stored on the blockchain ledger.

One or more embodiments of the present invention also provide an accurate and verifiable display history of the media content files due at least to the content display, verification and login logging that takes place.

Although embodiments of the invention have been described with reference to a particular arrangement of parts, features and the like, these are not intended to exhaust all possible arrangements or features, and indeed many other modifications and variations will be ascertainable to those of skill in the art.

As used herein, the term “data” refers to any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or internetwork.

The terms “first” and “second” are used to distinguish one element, set, data, object or thing from another, and are not used to designate relative position or arrangement in time.

The terms “coupled”, “coupled to”, and “coupled with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

What is claimed is:

1. A method for displaying electronic media, comprising:
receiving, by a controller of a customer display device of a subscriber, an electronic media collection for presentation at the display device, the electronic media collection comprising media content files and a placeholder for a custom generated media content file stored in a secure distributed database;
retrieving the custom generated media content file from the secure distributed database;
integrating the custom generated media content file with the media content files in the electronic media collection; and
displaying the electronic media collection including the custom generated media content file on the display device of the subscriber.

2. The method of claim 1, wherein prior to being stored, the custom generated media content file was segmented into a plurality of pieces, each piece stored on a different one of a plurality of nodes of the secure distributed database, wherein the retrieving comprises retrieving each of the plurality of pieces from the plurality of nodes of the secure distributed database and reassembling the custom generated media content file from the retrieved plurality of pieces of the custom generated media content file.

3. The method of claim 1, wherein prior to being stored, the custom generated media content file was encrypted, wherein the retrieving comprises retrieving the encrypted custom generated media content file and decrypting the encrypted custom generated media content file to create the custom generated media content file.

4. The method of claim 1, wherein accesses to the custom generated media content file are tracked and recorded.

5. The method of claim 1, wherein the electronic media collection is received from a service provider server.

6. The method of claim 5, wherein the secure distributed database is spread over a plurality of nodes on computers within a network managed by the service provider.

7. The method of claim 5, wherein the media content files and the placeholder are stored in a service provider storage device accessible by the service provider server.

8. The method of claim 1, wherein the placeholder comprising an identifier of the custom generated media content file and a pointer to a location of the customer generated media content file in the secure distributed database.

9. The method of claim 1, wherein the secure distributed database is spread over a plurality of nodes on computers within a network of the subscriber.

10. The method of claim 1, wherein the secure distributed database is a blockchain ledger.

11. A controller for displaying electronic media, the controller comprising:
a memory having computer readable instructions; and
one or more processors for executing the computer readable instructions, the computer readable instructions controlling the one or more processors to perform operations comprising:
receiving an electronic media collection for presentation at a customer display device of a subscriber controlled by the controller, the electronic media collection comprising media content files and a placeholder for a custom generated media content file stored in a secure distributed database;
retrieving the custom generated media content file from the secure distributed database;
integrating the custom generated media content file with the media content files in the electronic media collection; and
displaying the electronic media collection including the custom generated media content file on the display device of the subscriber.

12. The controller of claim 11, wherein prior to being stored, the custom generated media content file was segmented into a plurality of pieces, each piece stored on a different one of a plurality of nodes of the secure distributed database, wherein the retrieving comprises retrieving each of the plurality of pieces from the plurality of nodes of the secure distributed database and reassembling the custom generated media content file from the retrieved plurality of pieces of the custom generated media content file.

13. The controller of claim 11, wherein prior to being stored, the custom generated media content file was encrypted, wherein the retrieving comprises retrieving the encrypted custom generated media content file and decrypting the encrypted custom generated media content file to create the custom generated media content file.

14. The controller of claim 11, wherein accesses to the custom generated media content file are tracked and recorded.

15. The controller of claim 11, wherein the electronic media collection is received from a service provider server.

16. The controller of claim 15, wherein the secure distributed database is spread over a plurality of nodes on computers within a network managed by the service provider.

17. The controller of claim 15, wherein the media content files and the placeholder are stored in a service provider storage device accessible by the service provider server.

18. The controller of claim 1, wherein the secure distributed database is a blockchain ledger.

19. A computer program product for displaying electronic media, the computer program product comprising a non-transitory computer readable storage medium having program instructions embodied therewith, the program instructions executable by a processor to cause the processor to perform operations comprising:
receiving an electronic media collection for presentation at a customer display device of a subscriber controlled by the controller, the electronic media collection comprising media content files and a placeholder for a custom generated media content file stored in a secure distributed database;
retrieving the custom generated media content file from the secure distributed database;
integrating the custom generated media content file with the media content files in the electronic media collection; and
displaying the electronic media collection including the custom generated media content file on the display device of the subscriber.

20. The computer program product of claim 19, wherein the secure distributed database is a blockchain ledger.
